(19) United States
(12) Patent Application Publication
(10) Pub. No.: US 2015/0207602 A1
(43) Pub. Date: Jul. 23, 2015

(54) PILOT MAPPING FOR MU-MIMO

(71) Applicant: QUALCOMM Incorporated, San Diego, CA (US)

(72) Inventors: Lin YANG, San Diego, CA (US); Albert VAN ZELST, Woerden (NL); Bin TIAN, San Diego, CA (US); Sameer VERMANI, San Diego, CA (US)

(21) Appl. No.: 14/601,082

(22) Filed: Jan. 20, 2015

Related U.S. Application Data
(60) Provisional application No. 61/929,957, filed on Jan. 21, 2014.

(51) Int. Cl. H04L 5/00; H04B 7/04

(52) U.S. Cl. CPC H04L 5/0048; H04B 7/0452

(57) ABSTRACT

Certain aspects of the present disclosure relate to techniques, methods, and apparatuses for generating pilot sequences for use in uplink (UL) multi-user multiple input-multiple output (MU-MIMO) transmissions

### CROSS-REFERENCE TO RELATED APPLICATIONS

This application claims benefit of U.S. Provisional Patent Application Ser. No. 61/929,957, filed Jan. 21, 2014, which is expressly herein incorporated by reference.

### BACKGROUND

1. Field of the Invention

Certain aspects of the present disclosure generally relate to wireless communications and, more particularly, pilot sequences for use in uplink (UL) multi-user multiple input-multiple output (MU-MIMO) transmissions.

2. Relevant Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz frequency range (e.g., operating in the 902-928 MHz range in the United States) being developed by the Institute of Electrical and Electronics Engineers (IEEE) 802.11ah task force. This development is driven by the desire to utilize a frequency range that has greater wireless range than wireless ranges associated with frequency ranges of other Institute of Electrical and Electronic Engineers (IEEE) 802.11 technologies and potentially fewer issues associated with path losses due to obstructions.

### SUMMARY

Aspects of the present disclosure provide an apparatus for wireless communications. The apparatus generally includes a processing system configured to generate at least one sequence of pilots for one or more of a plurality of spatial streams of a multi user multiple input-multiple output (MIMO) transmission, wherein the at least one sequence of pilots is distinguishable from at least one other sequence of pilots transmitted by the apparatus or other apparatuses and an interface for outputting the sequence of pilots for transmission to a device in the MIMO transmission.

Aspects of the present disclosure provide method for wireless communications. The method generally includes generating at least one sequence of pilots for one or more of a plurality of spatial streams of a multi user multiple input-multiple output (MIMO) transmission, wherein the at least one sequence of pilots is distinguishable from at least one other sequence of pilots transmitted by the apparatus or other apparatuses and outputting the sequence of pilots for transmission to a device in the MIMO transmission.

Aspects of the present disclosure provide an apparatus for wireless communications. The apparatus generally includes means for generating at least one sequence of pilots for one or more of a plurality of spatial streams of a multi user multiple input-multiple output (MIMO) transmission, wherein the at least one sequence of pilots is distinguishable from at least one other sequence of pilots transmitted by the apparatus or other apparatuses and means for outputting the sequence of pilots for transmission to a device in the MIMO transmission.

Aspects of the present disclosure provide a computer program product for wireless communications by an apparatus, comprising a computer-readable medium having code stored thereon for generating at least one sequence of pilots for one or more of a plurality of spatial streams of a multi user multiple input-multiple output (MIMO) transmission, wherein the at least one sequence of pilots is distinguishable from at least one other sequence of pilots transmitted by the apparatus or other apparatuses and outputting the sequence of pilots for transmission to a device in the MIMO transmission.

Aspects of the present disclosure provide a station. The station generally includes at least one antenna, a processing system configured to generate at least one sequence of pilots for one or more of a plurality of spatial streams of a multi user multiple input-multiple output (MIMO) transmission, wherein the at least one sequence of pilots is distinguishable from at least one other sequence of pilots transmitted by the station or other stations, and a transmitter for transmitting, via the at least one antenna, the sequence of pilots to a device in the MIMO transmission.

Aspects of the present disclosure provide an apparatus for wireless communications. The apparatus generally includes an interface for obtaining a first sequence of pilots for one or more spatial streams associated with a first multiple input multiple output (MIMO) transmission from a first device and a second sequence of pilots for one or more spatial streams associated with a second MIMO transmission from a second device and a processing system configured to perform phase tracking for the first device and the second device based on the first sequence of pilots and the second sequence of pilots.

Aspects of the present disclosure provide method for wireless communications. The method generally includes obtaining a first sequence of pilots for one or more spatial streams associated with a first multiple input multiple output (MIMO) transmission from a first device and a second sequence of pilots for one or more spatial streams associated with a second MIMO transmission from a second device and performing phase tracking for the first device and the second device based on the first sequence of pilots and the second sequence of pilots.

Aspects of the present disclosure provide an apparatus for wireless communications. The apparatus generally includes means for obtaining a first sequence of pilots for one or more spatial streams associated with a first multiple input multiple output (MIMO) transmission from a first device and a second sequence of pilots for one or more spatial streams associated with a second MIMO transmission from a second device and means for performing phase tracking for the first device and the second device based on the first sequence of pilots and the second sequence of pilots.

Aspects of the present disclosure provide a computer program product for wireless communications by an apparatus, comprising a computer-readable medium having code stored thereon for obtaining a first sequence of pilots for one or more spatial streams associated with a first multiple input multiple output (MIMO) transmission from a first device and a second sequence of pilots for one or more spatial streams associated with a second MIMO transmission from a second device and performing phase tracking for the first device and the second device based on the first sequence of pilots and the second sequence of pilots.

Aspects of the present disclosure provide an access point. The access point generally includes at least one antenna, a receiver for receiving, via the at least one antenna, a first sequence of pilots for one or more spatial streams associated with a first multiple input multiple output (MIMO) transmission from a first device and a second sequence of pilots for one or more spatial streams associated with a second MIMO transmission from a second device, and a processing system configured to perform phase tracking for the first device and the second device based on the first sequence of pilots and the second sequence of pilots.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates a block diagram of example operations for wireless communications by an apparatus, in accordance with certain aspects of the present disclosure.

FIG. 4A illustrates example means capable of performing the operations shown in FIG. 4.

FIG. 5 illustrates a block diagram of example operations for wireless communications by an apparatus, in accordance with certain aspects of the present disclosure.

FIG. 5A illustrates example means capable of performing the operations shown in FIG. 5.

FIG. 6 illustrates an example pilot mapping matrix, in accordance with certain aspects of the present disclosure.

FIG. 7 illustrates an example pilot mapping matrix, in accordance with certain aspects of the present disclosure.

FIG. 8 illustrates an example pilot mapping matrix, in accordance with certain aspects of the present disclosure.

FIG. 9 illustrates an example MU-MIMO transmission utilizing pilot values generated in accordance with aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In uplink (UL) multi-user (MU) MIMO (MU-MIMO), an AP may need to perform per-user phase tracking and per-stream phase offset correction in order to maintain a good connection and minimize interference. As a result, it may be desirable to include MIMO pilots for UL MU-MIMO receiving. Thus, aspects of the present disclosure provide techniques for generating and utilizing UL MU-MIMO pilot sequences, such that pilot sequences for different users and/or streams may be distinguishable by an AP. This may allow the AP to perform per-user phase tracking and per-stream phase offset correction.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (AP) may comprise, be implemented as, or known as a Node B, Radio Network Controller (RNC), evolved Node B (eNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology.

An access terminal (AT) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (SIP) phone, a wireless local loop (WLL) station, a personal digital assistant (PDA), a handheld device having wireless connection capability, a Station (STA), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium.

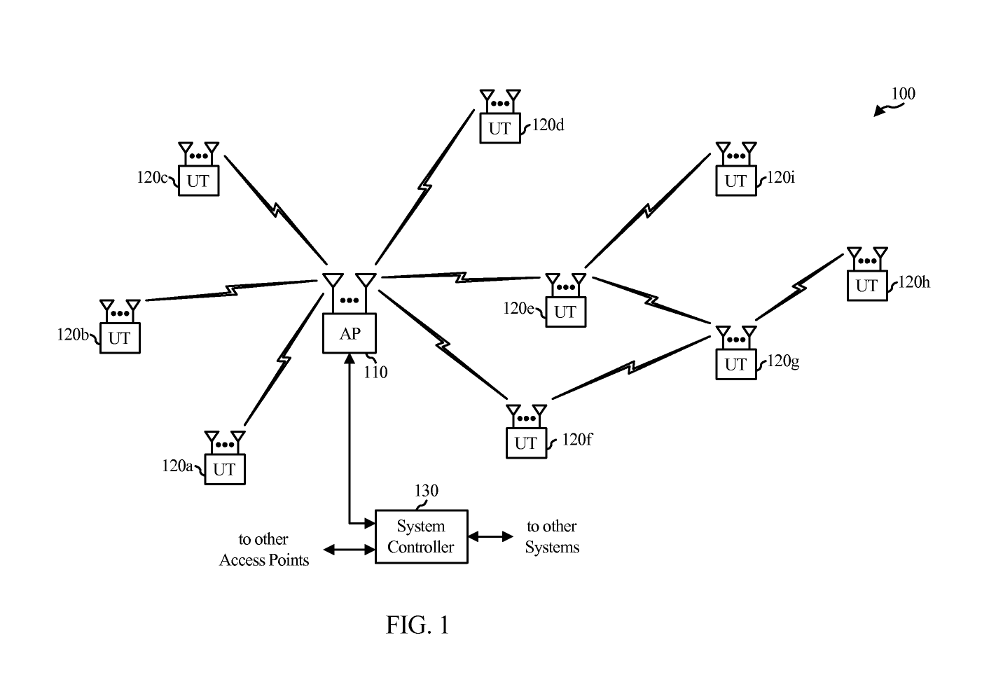

FIG. 1 shows a wireless communication network 100, in which aspects of the present disclosure may be performed. For example, user terminals 120 may utilize the techniques described herein to generate and utilize UL MU-MIMO pilot sequences, such that pilot sequences for different users and/or streams may be distinguishable (e.g., orthogonal) by an AP (e.g., AP 110).

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal A system controller 130 couples to and provides coordination and control for the access points.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The SDMA system may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

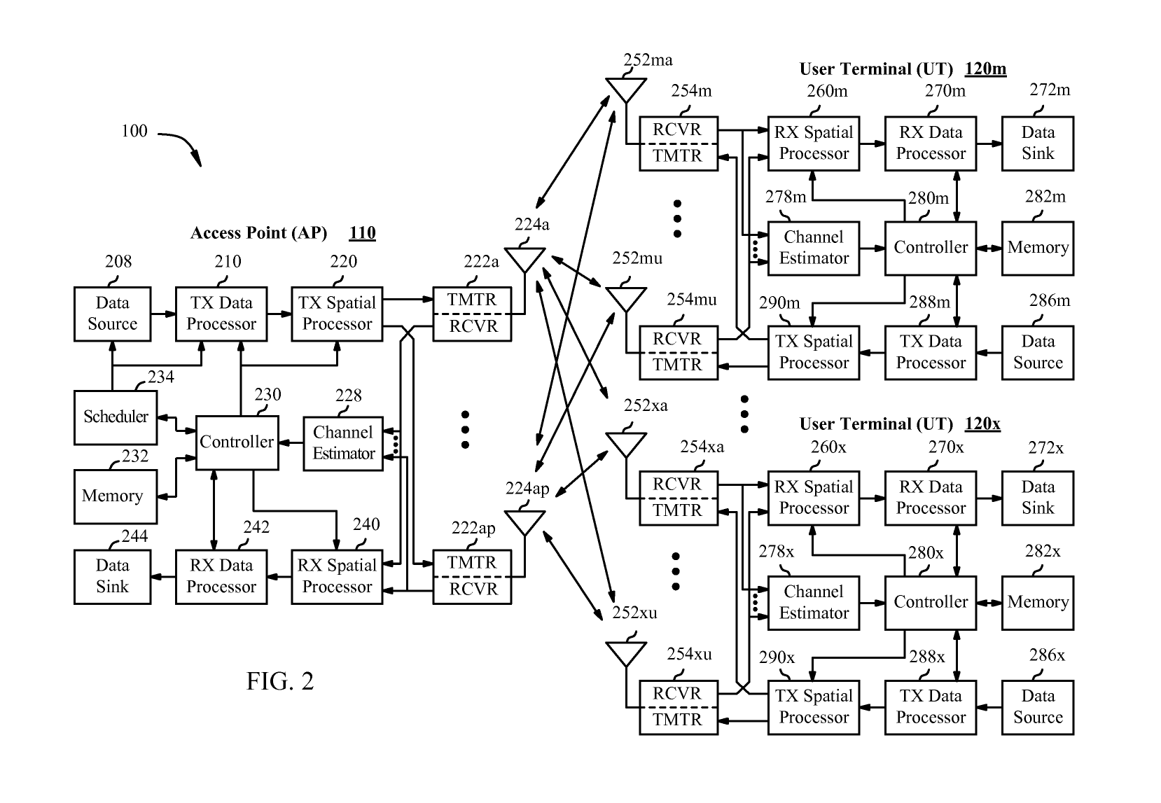

FIG. 2 illustrates a block diagram of access point 110 and two user terminals 120m and 120x in MIMO system 100 in which aspects of the present disclosure may be performed. For example, UE 120 may utilize techniques described herein to generate and utilize UL MU-MIMO pilot sequences, such that pilot sequences for different users and/or streams may be distinguishable by an AP (e.g., AP 110).

The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or controller 280 for further processing.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

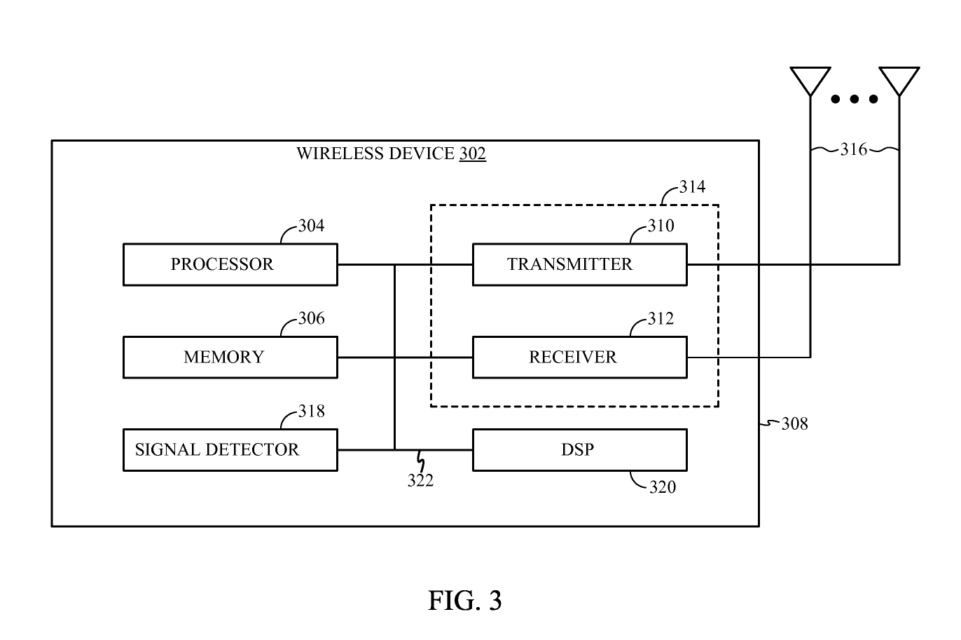

FIG. 3 illustrates various components that may be utilized in a wireless device 302 that may be employed within the MIMO system 100. The wireless device 302 is an example of a device that may be configured to implement the various methods described herein. For example, the wireless device may generate and utilize UL MU-MIMO pilot sequences. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Pilot Mapping for UL MU-MIMO

As noted above, on UL MU-MIMO, an AP may need to perform per-user phase tracking and per-stream phase offset correction in order to maintain a good connection and minimize interference. As a result, it may be desirable to include MIMO pilots for UL MU-MIMO receiving.

However, certain systems may utilize single stream pilots, having not considered UL MU-MIMO. Thus, aspects of the present disclosure provide techniques for generating and utilizing UL MU-MIMO pilot sequences, such that pilot sequences for different users and/or streams may be distinguishable (e.g., orthogonal) by an AP. This may allow the AP to perform per-user phase tracking and per-stream phase offset correction. The techniques may be applied in various systems, such as those systems utilizing 20/40/80/160 MHz.

According to certain aspects, the pilot sequences may be obtained via Orthogonal Space-Time and Orthogonal Space-Frequency Pilot Mappings, Orthogonal Space-Frequency Pilot Mappings, or obtained as Single Stream Pilots.

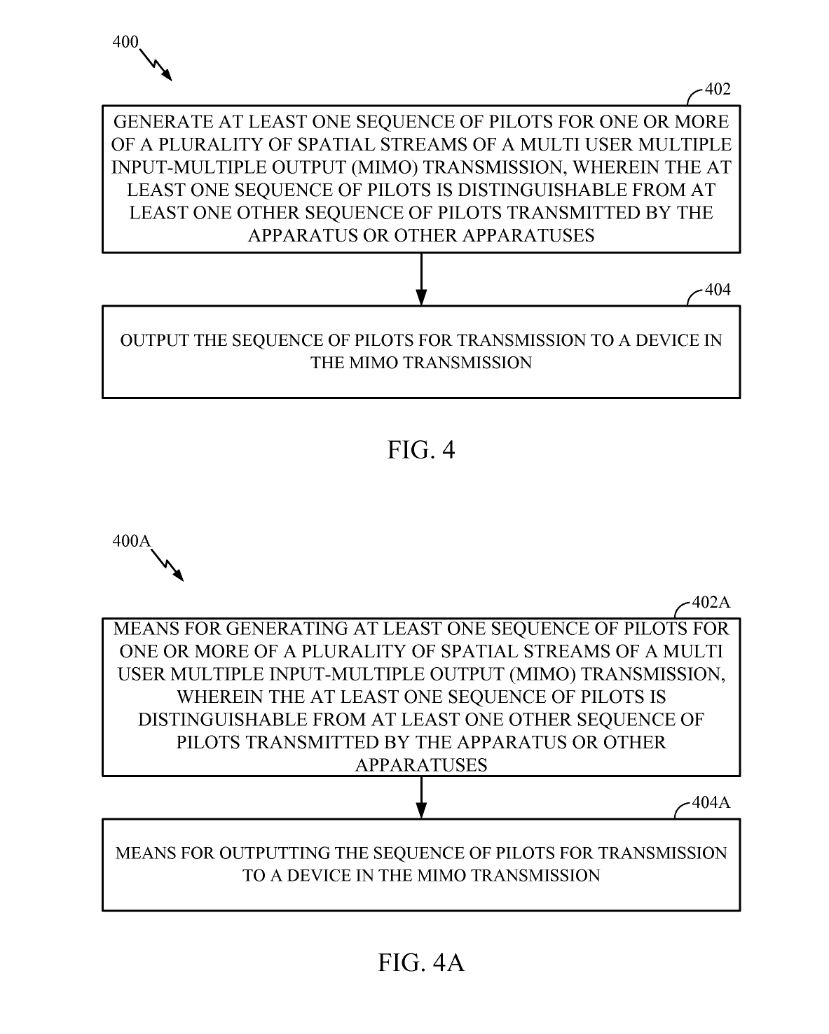

FIG. 4 illustrates example operations 400 for communicating in a wireless network according to certain aspects of the disclosure. The operations 400 may be performed, for example, by one of a group of wireless stations participating in MU-MIMO communications with an access point.

The operations 400 begin, at 402, by generating at least one sequence of pilots for one or more of a plurality of spatial streams of a multi user multiple input-multiple output (MIMO) transmission, wherein the at least one sequence of pilots is distinguishable from at least one other sequence of pilots transmitted by the apparatus or other apparatuses. At 404, the station may output the sequence of pilots for transmission to a device in the MIMO transmission.

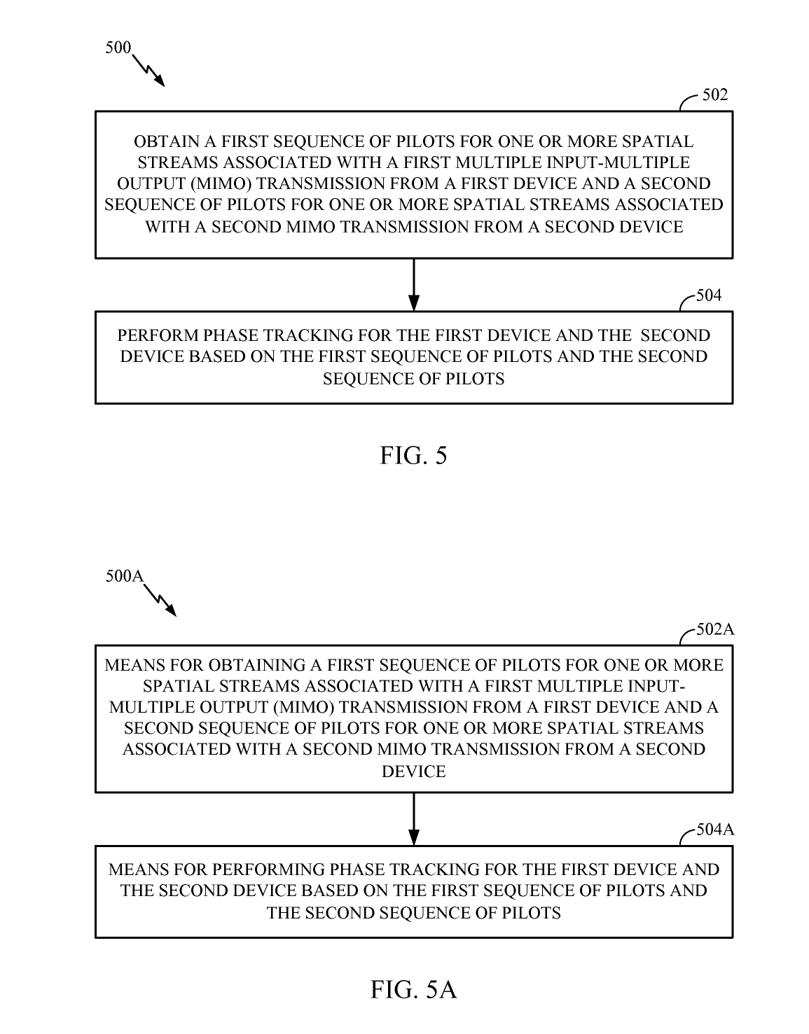

FIG. 5 illustrates example operations 500 for communicating in a wireless network according to certain aspects of the disclosure. The operations 500 may be performed, for example, by an access point participating in MU-MIMO communications with a group of wireless stations (e.g., performing operation 400).

The operations 500 begin, at 502, by obtaining (receiving) a first sequence of pilots for one or more spatial streams associated with a first multiple input multiple output (MIMO) transmission from a first device and a second sequence of pilots for one or more spatial streams associated with a second MIMO transmission from a second device. At 504, the access point may perform phase tracking for the first device and the second device based on the first sequence of pilots and the second sequence of pilots.

According to aspects of the present disclosure, different streams may use different pilot sequences (e.g., from one of the orthogonal mapping options described below) or all streams may use the same pilot sequence (referred to below as a “single stream sequence”). According to certain aspects, which may be referred to as a fixed pilots case, one pilot may be transmitted at the same tone for different MIMO streams.

According to certain aspects, the pilot sequences may be generated based on orthogonal space-time and orthogonal space-frequency pilot mappings. This may be beneficial, as orthogonal pilot design may be more robust for highly correlated channels.

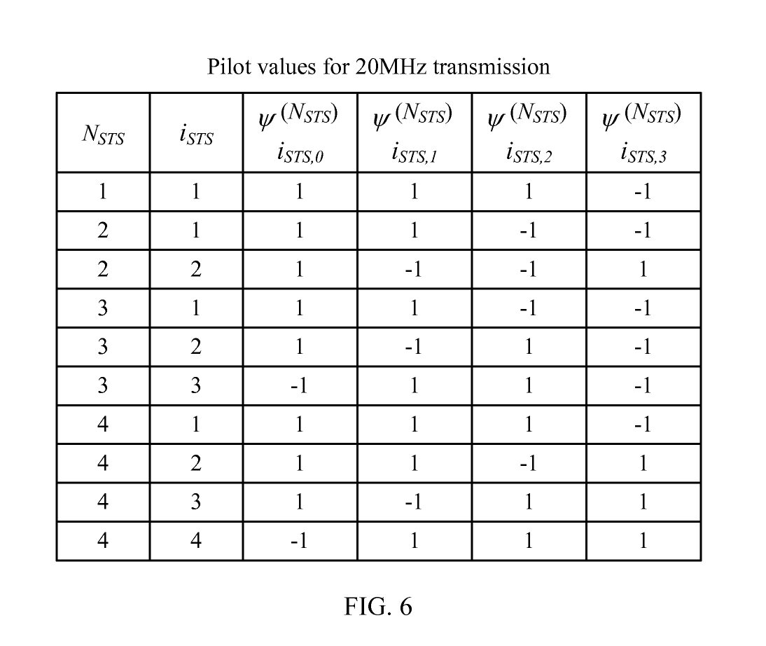

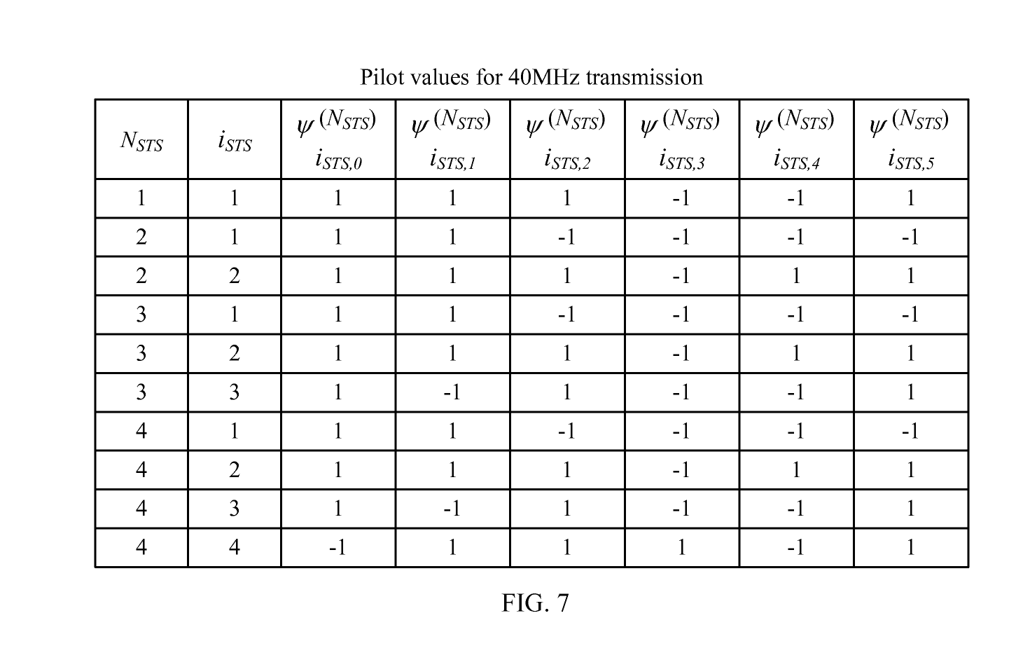

In UL MU-MIMO, an orthogonal pilot mapping may help (an AP) distinguish between multiple users. Certain pilots (e.g., non-UL MU-MIMO 802.11n pilots) had been designed to be orthogonal between spatial streams, both in frequency and in time, for 20/40 MHz, as shown in FIGS. 6 and 7 (note that not all pilot tones in 40 MHz are time domain orthogonal), respectively. According to certain aspects of the present disclosure, such mappings may be used for UL MU-MIMO pilot sequences. For example, 20 MHz/40 MHz UL MU-MIMO transmissions may use the pilot sequences shown in FIGS. 6 and/or 7.

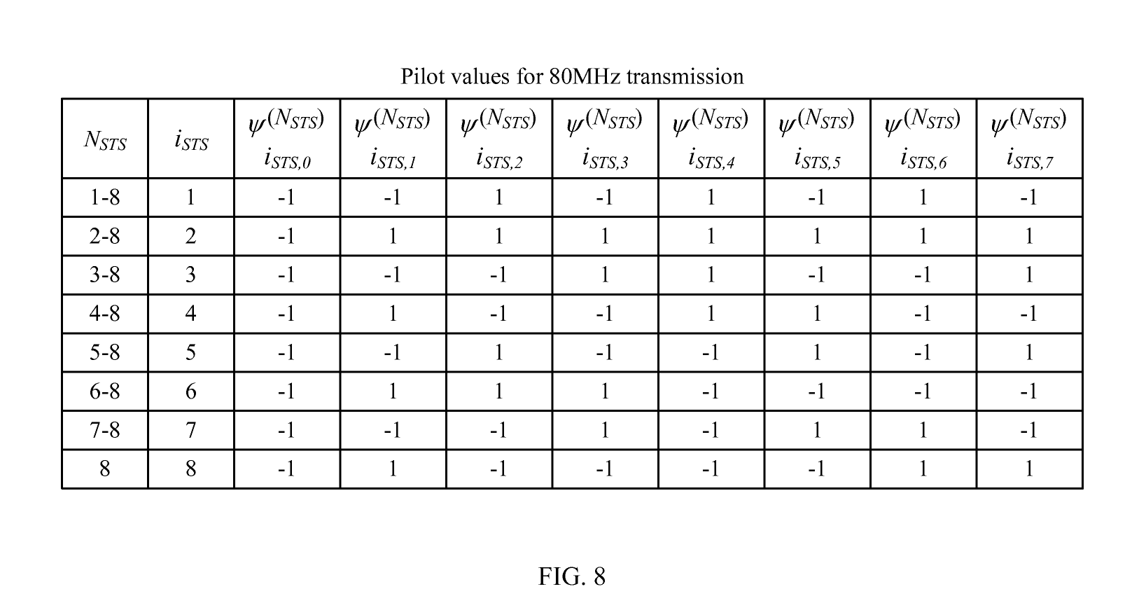

In some cases (e.g., for 80 MHz operation), however, new orthogonal pilot mappings may be used, such as shown in FIG. 8. As illustrated, the pilot sequences may be formed, for example, by a natural ordered Hadamard matrix, with 1st column changed to all “−1”s. In some cases, for a single stream (i.e., Nₛₜₛ=1), if space-time-frequency orthogonality is needed, the sequence may be [1 1 1 −1 1 1 1 −1]. The peak to average power ratio (PAPR) of the 80 MHz pilots (with 8 tones) may not have as much of an impact as the PAPR of the data portion (with 234 tones) dominants.

In some cases, the pilot tone mapping in 80 MHz may be determined by the following equation:

Pₙ^{{-103,-75,-39,-11.11,39,75,103}}={Ψᵢ_{ₛₜₛ}_{,n mod 8}^{N}^{ₛₜₛ}, Ψᵢ_{ₛₜₛ}_{,(n+1)mod 8}^{N}^{ₛₜₛ}, Ψᵢ_{ₛₜₛ}_{,(n+2)mod 8}^{N}^{ₛₜₛ}, Ψᵢ_{ₛₜₛ}_{,(n+3)mod 8}^{N}^{ₛₜₛ}, . . . Ψᵢ_{ₛₜₛ}_{,(n+4)mod 8}^{N}^{ₛₜₛ}, Ψᵢ_{ₛₜₛ}_{,(n+5)mod 8}^{N}^{ₛₜₛ}, Ψᵢ_{ₛₜₛ}_{,(n+6)mod 8}^{N}^{ₛₜₛ}, Ψᵢ_{ₛₜₛ}_{,(n+7)mod 8}^{N}^{ₛₜₛ}}

where n is the DATA symbol index starting at 0. In some cases, new orthogonal pilots may be needed for 20/40 MHz with a number of streams over 4 (i.e., Nₛₜₛ>4).

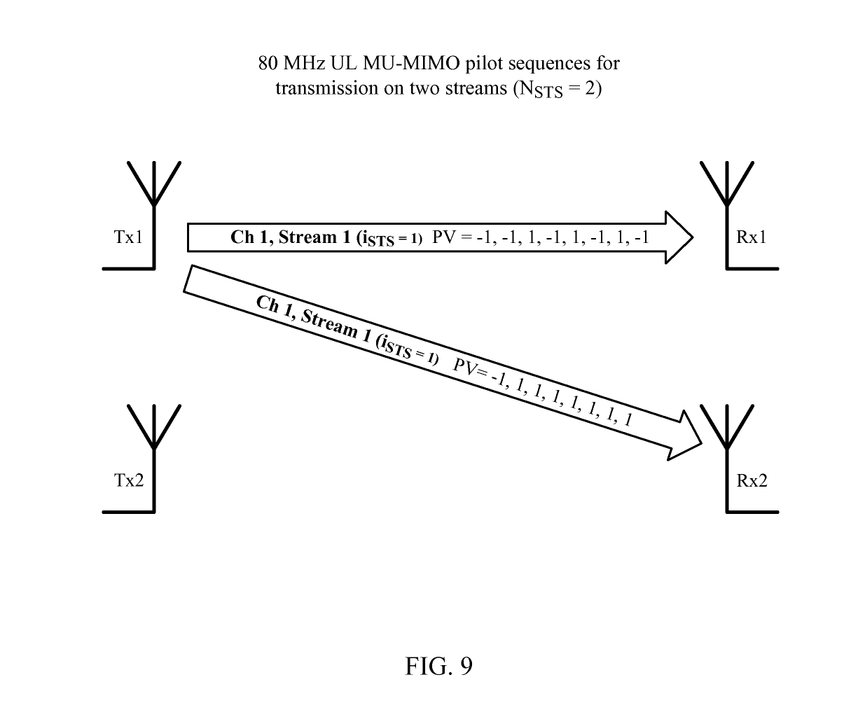

FIG. 9 illustrates an example UL MU-MIMO transmission of pilot values for 80 MHz, utilizing the pilot values from FIG. 8. As shown in FIG. 9, the UL-MIMO transmission comprises two streams (i.e., N_{STS}=2), Steam 1 and Stream 2. Additionally as shown and with reference to the table in FIG. 8, Stream 1 (i.e., i_{STS=1}) comprises the pilot values associated with N_{STS}=2 and i_{STS}=1 (i.e., −1,−1,1,−1,1,−1,1,−1) while Stream 2 comprises the pilot values associated with N_{STS}=2 and i_{STS}=2 (−1, 1, 1, 1, 1, 1, 1,).

According to certain aspects, the orthogonal pilots for 80 MHz may be determined according to the following equation,

Pᵢ_{ₛₛ}^{(k,n)}=W(iₛₛ, n mod 8)*P_{8×8}(iₛₛ, k)

where the Walsh matrix, W=[W4 W4; W4−W4] and W4=[1 1 1 1; 1 −1 1 −1; 1 1 −1−1; 1 −1 −1 1], may be used to provide space-time orthogonality. Additionally, P_{8×8} may be a 8×8 P matrix (e.g., as defined in 802.11ac) used to provide space-frequency orthogonality.

According to certain aspects, for 160 MHz transmission, 80 MHz pilot mapping, as described above, may be replicated in two 80 MHz subchannels of the 160 MHz transmission. In other words, the pilot sequences described above may be used, but with each pilot sequence transmitted in both of the 80 MHz subchannels.

In some cases, orthogonal space-frequency pilot sequences, as opposed to pilot sequences that are also space-time orthogonal, may be used for UL MU-MIMO. Using only orthogonal space-frequency pilots may be acceptable since, in practice, orthogonal space-time mapping may not always be beneficial in terms of demodulation performance. For example, in some cases it may be better to increase the loop bandwidth of a phase locked loop (PLL) for good settling behavior. However, averaging over time to enhance pilot tracking may not work well in some cases with increased loop bandwidth due to the high frequency phase noise.

If only space-frequency orthogonality is considered, various types of orthogonal codes may be used for MIMO pilot mapping (e.g., Walsh sequence or PN sequence if only BPSK is allowed, or may be FFT sequence). As an example, for 20/40 MHz, the sequences for Nₛₜₛ=4 shown in the tables of FIGS. 6 and 7 may be used in cases for any spatial stream index with four spatial streams or less (i.e., Nₛₜₛ<=4). In this case, there may still be a need for new orthogonal pilot sequences for 20/40 MHz with a number of spatial streams over four (i.e., Nₛₜₛ>4).

For space-frequency orthogonality in 80 MHz UL MU-MIMO, it may be possible to use the sequences in the table illustrated in FIG. 8, for any spatial stream index (i.e., i_{STS}) with the number of spatial streams less than or equal to eight (i.e., Nsts<=8). It may also be possible for 80 MHz to use the sequences in FIG. 8 without Walsh covering (i.e. 8×8 P matrix) for any spatial stream index with Nₛₜₛ<=8.

As with the orthogonal space-time and orthogonal space-frequency pilot tone mapping, the pilot tone mapping for space-frequency orthogonality in 80 MHz UL MU-MIMO may be determined by the following equation,

P_{N}^{{-103,-75,-39,-11.11,39,75,103}}={Ψᵢ_{ₛₜₛ}_{,n mod 8}^{N}^{ₛₜₛ}, Ψᵢ_{ₛₜₛ}_{,(n+1)mod 8}^{N}^{ₛₜₛ}, Ψᵢ_{ₛₜₛ}_{,(n+2)mod 8}^{N}^{ₛₜₛ}, Ψᵢ_{ₛₜₛ}_{,(n+3)mod 8}^{N}^{ₛₜₛ}, . . . Ψᵢ_{ₛₜₛ}_{,(n+4)mod 8}^{N}^{ₛₜₛ}, Ψᵢ_{ₛₜₛ}_{,(n+5)mod 8}^{N}^{ₛₜₛ}, Ψᵢ_{ₛₜₛ}_{,(n+6)mod 8}^{N}^{ₛₜₛ}, Ψᵢ_{ₛₜₛ}_{,(n+7)mod 8}^{N}^{ₛₜₛ}}

where n is the DATA symbol index starting at 0.

The example 20/40/80 MHz transmissions referred to in the present disclosure may generally correspond to transmissions with 1× symbol duration (i.e., as with 802.11ac pilot transmissions), such that the corresponding number of pilots is 4 for 20 MHz, 6 for 40 MHz, and 8 for 80 MHz. However, in some cases, a different symbol duration may be specified as the only operational mode, such as a 4× symbol duration specified in 802.11ax. As such, for an 802.11ax packet, the FFT size may be 4 times that of 11ac with same bandwidth. Additionally, in some cases, the 802.11ax 20 MHz 4× tone plan may use the same number of pilots and data tones as 802.11ac 80 MHz tone plan (which uses a 1× symbol duration). Thus, according to certain aspects, the pilot mapping for 80 MHz 1× with 8 pilots may be directly used for flax 20 MHz with 4× symbol duration.

Accordingly, the pilot mapping matrices proposed herein (e.g., in FIGS. 6-8) may be considered essentially related to the number of pilots and not necessarily strictly related to a transmission bandwidth. In other words, transmissions with different numbers of pilots may need to use a different mapping table or may use a subset of a larger mapping matrix.

In some cases, depending on a condition, single stream pilots may be used instead of MIMO pilots. For example, in UL spatial division multiple access (SDMA), there may be a high likelihood that the channels from different users/streams may be relatively independent. In this case, even the space-frequency orthogonality may not be strictly needed. Therefore, single stream pilots may be used, particularly, if cyclic shift diversity (CSD) is used (e.g., by applying a different cyclic shift delay (CSD) for each spatial stream) with each stream to break the beam-forming pattern. According to certain aspects, an apparatus receiving the single stream pilots may be configured to distinguish each the spatial streams based on the corresponding CSD. Furthermore, if each user is associated with a different channel, the orthogonality may be helpful only if combining over frequency for a given spatial stream or over streams that belong to the same user is performed.

In some cases, when using single stream pilots in UL MU MIMO for a first bandwidth (e.g., 80 MHz), an existing pilot sequence (e.g., defined per 802.11 ac) may be used for the pilot mapping. For other bandwidths (e.g., 20/40 MHz), the single stream pilots may be based on a pilot sequence discussed herein for the single stream case (e.g., the first row in the tables illustrated in FIGS. 6 and 7).

In some cases, the pilot sequence may be the same for all streams or users when using single stream pilots. In some cases, however, the pilot sequence may be allowed to vary from user to user.

According to certain aspects, a decision of whether to use single stream pilots or MIMO pilots may depend on a particular scenario, for example, depending on which gives a desired performance. In some cases, devices may dynamically switch between using single stream and MIMO pilots. For example, if performance degrades when using one type of pilot, the system may switch to the other type of pilots (e.g., with the switching controlled by the AP). In some cases, the decision of whether to use single stream pilots or MIMO pilots may depend on a geographical location of users (stations). For example, for independently located (not co-located) users, single stream pilots may be used for simplicity while preserving performance. For co-located users, on the other hand, MIMO pilots may be used to improve performance across the co-located users.

According to certain aspects, by using single stream pilots (e.g., as defined in 802.11ac) with CSD per stream for UL MU-MIMO, phase tracking performance may be sufficiently accurate. This technique may be relatively simple and may avoid having to make decisions on which orthogonal codes should be used, which might all have similar performance. In some cases, however, the effectiveness of single stream pilots may depend on how much correlation can be tolerated in a high-correlation (e.g., co-located) scenario, given the independent frequency offset per user and per user phase tracking.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 400 and 500 illustrated in FIGS. 4 and 5 correspond to means 400A and 500A illustrated in FIGS. 4A and 5A.

For example, means for transmitting (or outputting) may comprise a transmitter (e.g., the transmitter unit 222) and/or an antenna(s) 224 of the access point 110 illustrated in FIG. 2 or the transmitter 310 and/or antenna(s) 316 depicted in FIG. 3. Means for receiving (or obtaining) may comprise a receiver (e.g., the receiver unit 222) and/or an antenna(s) 224 of the access point 110 illustrated in FIG. 2 or the receiver 312 and/or antenna(s) 316 depicted in FIG. 3.

Means for generating and means for determining may comprise a processing system, which may include one or more processors, such as the RX data processor 242, the TX data processor 210, and/or the controller 230 of the access point 110 illustrated in FIG. 2 or the processor 304 and/or the DSP 320 portrayed in FIG. 3.

According to certain aspects, such means may be implemented by processing systems configured to perform the corresponding functions by implementing various algorithms (e.g., in hardware or by executing software instructions) described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Furthermore, “determining” may include resolving, selecting, choosing, establishing and the like.

As used herein, the term “outputting” may involve actual transmission or output of a structure from one entity (e.g., a processing system) to another entity (e.g., an RF front end or modem) for transmission. As used herein, the term “obtaining” may involve actual receiving of a structure transmitted over the air or obtaining the structure by one entity (e.g., a processing system) from another entity (e.g., an RF front end or modem).

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer readable storage medium with instructions stored thereon separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by an apparatus such as the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to generate at least one sequence of pilots for one or more of a plurality of spatial streams of a multi user multiple input-multiple output (MIMO) transmission, wherein the at least one sequence of pilots is distinguishable from at least one other sequence of pilots transmitted by the apparatus or other apparatuses; and
an interface for outputting the sequence of pilots for transmission to a device in the MIMO transmission.

2. The apparatus of claim 1, wherein the processing system is configured to determine, based on a condition, whether to generate the at least one sequence of pilots as:
a single pilot sequence for the plurality of spatial streams; or
at least a first sequence of pilots for a first spatial stream and a second sequence of pilots for a second spatial stream.

3. The apparatus of claim 2, wherein, for the single pilot sequence for the plurality of spatial streams, the processing system is configured to apply a different cyclic shift delay (CSD) for each spatial stream of the plurality of spatial streams.

4. The apparatus of claim 2, wherein:
a different sequence of pilots is allocated to each of the apparatus and the other apparatuses; and
the single pilot sequence for the plurality of spatial streams is based on a sequence of pilots allocated to the apparatus

5. The apparatus of claim 2, wherein the first sequence of pilots and the second sequence of pilots are at least one of orthogonal in frequency or orthogonal in time.

6. The apparatus of claim 2, wherein the first sequence of pilots and the second sequence of pilots are generated using a mapping matrix designed to generate sequences of pilots for different spatial streams that are orthogonal in frequency.

7. The apparatus of claim 2, wherein the first sequence of pilots and the second sequence of pilots are generated using a mapping of pilot values to different pilot tones.

8. The apparatus of claim 2, wherein the first sequence of pilots and the second sequence of pilots comprise pilots to be transmitted in different subchannels of bandwidth used for the MIMO transmission.

9. The apparatus of claim 8, wherein the first sequence of pilots and the second sequence of pilots to be transmitted in different subchannels of bandwidth used for the MIMO transmission are generated using a Walsh matrix designed to generate sequences of pilots for different spatial streams that are orthogonal in time.

10. An apparatus for wireless communications, comprising:
an interface for obtaining a first sequence of pilots for one or more spatial streams associated with a first multiple input multiple output (MIMO) transmission from a first device and a second sequence of pilots for one or more spatial streams associated with a second MIMO transmission from a second device; and
a processing system configured to perform phase tracking for the first device and the second device based on the first sequence of pilots and the second sequence of pilots.

11. The apparatus of claim 10, wherein:
the first sequence of pilots comprises a single pilot sequence with a different cyclic shift delay (CSD) applied for each of a plurality of spatial streams transmitted from the first device; and
the processing system is configured to distinguish each of the plurality of spatial streams based on a corresponding CSD.

12. The apparatus of claim 10, wherein the interface obtains pilots for the first sequence of pilots and the second sequence of pilots in different subchannels of bandwidth used for the MIMO transmission.

13. The apparatus of claim 10, wherein:
the first sequence of pilots and the second sequence of pilots are orthogonal in at least one of frequency or time; and
the processing system is configured to distinguish between the first sequence of pilots and the second sequence of pilots based on the orthogonality in frequency or time.

14. The apparatus of claim 10, wherein different sequences of pilots are allocated to the first device and the second device and the processing system is configured to distinguish between the first device and the second device based on the different sequences of pilots.

15. A method for wireless communications by an apparatus, comprising:
generating at least one sequence of pilots for one or more of a plurality of spatial streams of a multi user multiple input-multiple output (MIMO) transmission, wherein the at least one sequence of pilots is distinguishable from at least one other sequence of pilots transmitted by the apparatus or other apparatuses; and
outputting the sequence of pilots for transmission to a device in the MIMO transmission.

16. The method of claim 15, further comprising determining, based on a condition, whether to generate the at least one sequence of pilots as:
a single pilot sequence for the plurality of spatial streams; or
at least a first sequence of pilots for a first spatial stream and a second sequence of pilots for a second spatial stream.

17. The method of claim 16, further comprising, for the single pilot sequence for the plurality of spatial streams, applying a different cyclic shift delay (CSD) for each spatial stream of the plurality of spatial streams.

18. The method of claim 16, wherein:
a different sequence of pilots is allocated to each of the apparatus and the other apparatuses; and
the single pilot sequence for the plurality of spatial streams is based on a sequence of pilots allocated to the apparatus.

19. The method of claim 16, wherein the first sequence of pilots and the second sequence of pilots are at least one of orthogonal in frequency or orthogonal in time.

20. The method of claim 16, wherein generating the first sequence of pilots and the second sequence of pilots comprises generating the first sequence of pilots and the second sequence of pilots using a mapping matrix designed to generate sequences of pilots for different spatial streams that are orthogonal in frequency.

21. The method of claim 16, wherein generating the first sequence of pilots and the second sequence of pilots comprises generating the first sequence of pilots and the second sequence of pilots using a mapping of pilot values to different pilot tones.

22. The method of claim 16, wherein outputting comprises outputting pilots for the first sequence of pilots and the second sequence of pilots in different subchannels of bandwidth used for the MIMO transmission.

23. The method of claim 22, wherein generating the first sequence of pilots and the second sequence of pilots comprises generating the first sequence of pilots and the second sequence of pilots using a Walsh matrix designed to generate sequences of pilots for different spatial streams that are orthogonal in time.

24. A method for wireless communications by an apparatus, comprising:
obtaining a first sequence of pilots for one or more spatial streams associated with a first multiple input multiple output (MIMO) transmission from a first device and a second sequence of pilots for one or more spatial streams associated with a second MIMO transmission from a second device; and
performing phase tracking for the first device and the second device based on the first sequence of pilots and the second sequence of pilots.

25. The method of claim 24, wherein:
the first sequence of pilots comprises a single pilot sequence with a different cyclic shift delay (CSD) applied for each of a plurality of spatial streams transmitted from the first device; and
distinguishing each of the plurality of spatial streams based on a corresponding CSD.

26. The method of claim 24, wherein obtaining pilots for the first sequence of pilots and the second sequence of pilots comprises obtaining the pilots for the first sequence pilots and the second sequence of pilots in different subchannels of bandwidth used for the MIMO transmission.

27. The method of claim 24, wherein:
the first sequence of pilots and the second sequence of pilots are orthogonal in at least one of frequency or time; and
further comprising distinguishing between the first sequence of pilots and the second sequence of pilots based on the orthogonality in frequency or time.

28. The method of claim 24, wherein different sequences of pilots are allocated to the first device and second device, and further comprising distinguishing between the first device and the second device based on the different sequences of pilots.

29-46. (canceled)
